(19) United States
(12) Patent Application Publication
(10) Pub. No.: US 2010/0199573 A1
(43) Pub. Date: Aug. 12, 2010

(54) ULTRAHARD DIAMOND COMPOSITES

(76) Inventors: Charles Stephan Montross, Springs (ZA); Thembinkosi Shabalala, Springs (ZA); Humphrey Sithebe, Springs (ZA)

Correspondence Address: FROMMER LAWRENCE & HAUG, 745 FIFTH AVENUE- 10TH FL., NEW YORK, NY, 10151, US

(21) Appl. No.: 12/664,202

(22) PCT Filed: Aug. 29, 2008
(86) PCT No.: PCT/IB08/53513

§ 371 Date: Apr. 20, 2010

(30) Foreign Application Priority Data
Aug. 31, 2007 (ZA) 2007/07467

(51) Int. Cl. B24D 3/04; E21B 10/46; B23B 27/20

(52) U.S. Cl. 51/307

(57) ABSTRACT

The invention is for an ultrahard composite material comprising a diamond phase and a binder phase, the binder phase comprising a ternary carbide of the general formula Mx M′y C wherein; M is at least one metal selected from the group consisting of the transition metals and the rare earth metals, M′ is a metal selected from the group consisting of the main group metals or metalloid elements and the transition metals Zn and Cd, x is from 2.5 to 5.0, y is from 0.5 to 3.0 and z is from 0.1 to 1. The invention extends to a diamond abrasive compact comprising such an ultrahard composite material and to a tool comprising such a diamond abrasive compact.

### BACKGROUND OF THE INVENTION

This invention relates to ultrahard composite materials of diamond having improved thermal stability.

Ultrahard diamond composite materials, typically in the form of abrasive compacts, are used extensively in cutting, milling, grinding, drilling and other abrasive operations, and also may be used as bearing surfaces and the like. They generally contain a diamond phase, typically diamond particles, dispersed in a second phase matrix or binder phase. The matrix may be metallic or ceramic or a cermet. These particles may be bonded to each other during the high pressure and high temperature compact manufacturing process generally used, forming polycrystalline diamond (PCD).

Polycrystalline diamond (PCD) is used extensively due its high abrasion resistance and strength. In particular, it may find use within shear cutting elements included in drilling bits used for subterranean drilling.

A commonly used tool containing a PCD composite abrasive compact is one that comprises a layer of PCD bonded to a substrate. The diamond particle content of these layers is typically high and there is generally an extensive amount of direct diamond-to-diamond bonding or contact. Diamond compacts are generally sintered under elevated temperature and pressure conditions at which the diamond particles are crystallographically or thermodynamically stable.

Examples of composite abrasive compacts can be found described in U.S. Pat. Nos. 3,745,623; 3,767,371 and 3,743,489.

The PCD layer of this type of abrasive compact will typically contain a catalyst/solvent or binder phase in addition to the diamond particles. This typically takes the form of a metal binder matrix, which is intermingled with the intergrown network of particulate diamond material. The matrix usually comprises a metal exhibiting catalytic or solvating activity towards carbon such as cobalt, nickel, iron or an alloy containing one or more such metals.

PCD composite abrasive compacts are generally produced by forming an unbonded assembly of the diamond particles and solvent/catalyst, sintering or binder aid material on a cemented carbide substrate. This unbonded assembly is then placed in a reaction capsule, which is then placed in the reaction zone of a conventional high pressure/high temperature apparatus. The contents of the reaction capsule are then subjected to suitable conditions of elevated temperature and pressure to enable sintering of the overall structure to occur.

It is common practice to rely, at least partially, on binder originating from the cemented carbide substrate as a source of metallic binder material for the sintered polycrystalline diamond. In many cases, however, additional metal binder powder is admixed with the diamond powder before sintering. This binder phase metal then functions as the liquid-phase medium for promoting the sintering of the diamond portion under the imposed sintering conditions.

The preferred solvent/catalysts or binder systems used to form PCD materials characterized by diamond-to-diamond bonding, which include Group VIIIA elements such as Co, Ni, Fe, and also metals such as Mn, are largely due to the high carbon solubility of these elements when molten. This allows some of the diamond material to dissolve and reprecipitate again as diamond, hence forming intercrystalline diamond bonding while in the diamond thermodynamic stability regime (at high temperature and high pressure). This intercrystalline diamond-to-diamond bonding is desirable because of the resulting high strength and wear resistance of the PCD materials.

The unfortunate result of using such solvent/catalysts is a process known in the literature as thermal degradation. This degradation occurs when the diamond composite material is subjected, in the presence of such solvent/catalyst material, to temperatures typically greater than 700° C. either under tool application or tool formation conditions. This temperature can severely limit the application of diamond composite materials generally, and PCD materials particularly in areas such as rock drilling or machining of materials.

Thermal degradation of PCD materials is postulated to occur via two mechanisms:
The first results from differences in the thermal expansion coefficients of the metallic solvent/catalyst binder and the intergrown diamond. Differential expansion at elevated temperature can cause micro-cracking of the intergrown diamond. It may become of particular concern even at temperatures exceeding 400° C.
The second is due to the inherent catalytic activity of the metallic solvent/catalyst in a carbon system. The metallic binder begins converting the diamond to non-diamond carbon when heated above approximately 700° C. This effect occurs appreciably even though the binder is still in the solid state. At low pressures, i.e. in the graphite stability regime, this results in the formation of non-diamond carbon, in particular graphitic carbon, the formation of which will ultimately cause bulk degradation of mechanical properties, leading to catastrophic mechanical failure. This second mechanism applies more generally to diamond composite materials comprising solvent/catalyst material, even where such material is absent significant diamond intergrowth.

One of the earliest methods of addressing this thermal degradation problem was disclosed in U.S. Pat. No. 4,224,380 and again in U.S. Pat. No. 6,544,308, comprising the removal of the solvent/catalyst through leaching by acids or electrochemical methods, which resulted in a porous PCD material that showed an improvement in the thermal stability. However, this resultant porosity caused a degradation of the mechanical properties of the PCD material. In addition, the leaching process is unable completely to remove isolated solvent/catalyst pools that are fully enclosed by intercrystalline diamond bonding. Therefore, the leaching approach is believed to result in a compromise in properties.

A further method for addressing thermal degradation involves the use of non-metallic or non catalyst/solvent binder systems. This is achieved, for example, through infiltration of the diamond compact with molten silicon or eutectiferous silicon, which then reacts with some of the diamond to form a silicon carbide binder in situ, as taught in U.S. Pat. Nos. 3,239,321; 4,151,686; 4,124,401; and 4,380,471, and also in U.S. Pat. No. 5,010,043 using lower pressures. This SiC-bonded diamond shows a clear improvement in thermal stability, capable of sustaining temperatures as high as 1200° C. for several hours as compared with PCD materials made using solvent/catalysts, which cannot tolerate temperatures above 700° C. for any appreciable length of time. However, there is no diamond-to-diamond bonding in SiC-bonded diamond compacts. Hence, although there may be some merit in this approach, the strength of these materials is limited by the strength of the SiC matrix, which results in materials of reduced strength and wear resistance.

Other methods of addressing the thermal degradation problem are taught by U.S. Pat. Nos. 3,929,432; 4,142,869 and 5,011,514. Here, the surface of the diamond powder is first reacted with a carbide-former such as tungsten or a Group IVA metal; and then the interstices between the coated diamond grit are filled with eutectic metal compositions such as silicides or copper alloys. Again, although thermal stability of the diamond is improved, there is no diamond-to-diamond bonding and the strength of this material is once again limited by the strength of the metal alloy matrix.

Another approach taken is to attempt to modify the behaviour of standard metallic solvent/catalysts in situ. U.S. Pat. No. 4,288,248 teaches the reaction of solvent/catalysts such as Fe, Ni, and Co with Cr, Mn, Ta, and Al to form intermetallic compounds. Similarly, in U.S. Pat. No. 4,610,699, standard metal catalysts are reacted with Group IV, V, VI metals in the diamond stability zone resulting in the formation of unspecified intermetallics. However, the formation of these intermetallic compounds within the catalyst interferes with diamond intergrowth and hence adversely affects material strength.

A more recent teaching using intermetallic compounds to provide thermal stability but still achieve high strength materials through diamond intergrowth is discussed in US2005/0230156. This application discusses the necessity of coating the diamond grit with the cobalt catalyst to allow polycrystalline diamond intergrowth before allowing interaction with the admixed intermetallic forming compounds. After the desired diamond intergrowth, it is postulated that the cobalt catalyst will then form an intermetallic which renders it non-reactive with the intergrown diamond.

In an exemplary embodiment of this patent application, silicon is admixed with the cobalt-coated diamond with the intention of protectively forming cobalt silicide in the binder after the desired diamond intergrowth occurs. Practically, however, it is well-known that silicon compounds will melt at lower temperatures than the cobalt coating, resulting in a first reaction between the cobalt and silicon before diamond intergrowth can occur in the presence of molten cobalt. Additionally, experimental results have shown that these cobalt silicides are not able to facilitate diamond intergrowth, even under conditions where they are molten. Further admixed intermetallic-forming compounds identified in this patent application are also known to form eutectics with melting temperatures below that of the cobalt coating. The end result is therefore that appreciable quantities of the intermetallic compounds form before diamond intergrowth can occur, which results in weak PCD materials due to reduced/no intergrowth.

U.S. Pat. Nos. 4,439,237 and 6,192,875 disclose metallurgically-bonded diamond-metal composites that comprise a Ni and/or Co base with a Sn, Sb, or Zn-based intermetallic compound dispersed therein. However, these are also not sintered under HpHT conditions, so no diamond intergrowth can be expected.

U.S. Pat. No. 4,518,659 discloses an HpHT process for the manufacture of diamond-based composites where certain molten non-catalyst metals (such as Cu, Sn, Al, Zn, Mg and Sb) are used in a pre-infiltration sweepthrough of the diamond powder in order to facilitate optimal catalytic behaviour of the solvent/catalyst metal. Here, although low levels of residual non-catalyst presence are anticipated to remain within the PCD body, these are not anticipated to be in sufficient quantities to result in significant intermetallic formation.

The problem addressed by the present invention is therefore the identification of a metallic binder system that provides for thermally stable diamond composite materials, which allows diamond dissolution and reprecipitation under diamond synthesis conditions, in particular to form intergrown PCD, but does not facilitate thermal degradation when the resultant composite material is used at elevated temperatures (above 700° C.) under ambient pressure conditions.

### SUMMARY OF THE INVENTION

According to the invention, an ultrahard composite material, in particular a polycrystalline diamond composite material, comprises a diamond phase and a binder phase, the binder phase comprising a ternary carbide of the general formula:

Mₓ M′_{y} C_{z}

wherein;

M is at least one metal selected from the group consisting of the transition metals and the rare earth metals;

M′ is a metal selected from the group consisting of the main group metals or metalloid elements and the transition metals Zn and Cd;

x is typically from 2.5 to 5.0, preferably from 2.5 to 3.5, and most preferably about 3;

y is typically from 0.5 to 3.0, preferably about 1; and

z is typically from 0.1 to 1, preferably from 0.5 to 1.

M is preferably selected from the group consisting of Co, Fe, Ni, Mn, Cr, Pd, Pt, V, Nb, Ta, Ti, Zr, Ce, Y, La and Sc.

M′ is preferably selected from the group consisting of Al, Ga, In, Ge, Sn, Pb, Tl, Mg, Zn and Cd, and in particular is Sn, In or Pb.

The ternary carbide preferably comprises at least 30 volume % of the binder phase, more preferably at least 40 volume % of the binder phase, even more preferably all of the binder phase with the exception of one or more other intermetallic compounds, such that no free or unbound M is present in the binder phase, and most preferably the ternary carbide comprises all of the binder phase.

The binder phase preferably comprises less than about 30 volume %, more preferably less than about 20 volume %, even more preferably less than about 15 volume %, and most preferably less than about 10 volume % of the ultrahard composite material.

The invention extends to a diamond abrasive compact comprising the diamond composite material of the invention, and to a tool comprising the diamond abrasive compact, which is capable of use in a cutting, milling, grinding, drilling or other abrasive application.

The diamond composite material may also be useful as a bearing surface.

### BRIEF DESCRIPTION OF THE FIGURES

The invention will now be described in more detail, by way of example only, with reference to the accompanying figures in which:

FIG. 1 is a binary phase diagram for a simple Co—Sn system illustrating various anticipated Co—Sn intermetallics;

FIG. 2 is a ternary phase diagram for a Co—Sn—C system illustrating the formation of various intermetallics and a ternary carbide incorporated into a preferred embodiment of a diamond composite material of the invention;

FIG. 3 is a high magnification scanning electron micrograph of a preferred embodiment of a diamond composite material of the invention;

FIG. 4 is a scanning electron micrograph of a further preferred embodiment of a diamond composite material of the invention; and

FIG. 5 is a scanning electron micrograph of yet another preferred embodiment of a diamond composite material of the invention.

### DETAILED DESCRIPTION OF EMBODIMENTS

The present invention is directed to an ultrahard composite material comprising diamond having increased thermal stability over conventional solvent/catalyst sintered diamond composite materials. The binder system specifically contains at least one intermetallic-based ternary carbide compound.

Transition metal carbides are well known to possess interesting and useful properties, and are typically used in refractory applications. A related group of compounds arises with the inclusion of non-transition metals or metalloids (M′) to yield a novel group of ternary carbides (MM′C), which may also be described as intermetallic carbides. These ternary carbides are typically sub-stoichiometric with respect to carbon, and tend to be brittle, pseudo-ceramic phases. Whilst they are currently under investigation in various advanced material science applications, they have not previously been disclosed as useful phases in the field of HpHT diamond synthesis or sintering.

The general class of ternary carbides of the invention have the general formula:

Mₓ M′_{y} C_{z}

wherein;

M is an element with high carbon solubility, which is typically a transition metal or rare earth metal and is preferably a solvent/catalyst for diamond synthesis;

M′ is a metal which is typically a non-transition or main group metal or metalloid element;

x is typically from 2.5 to 5.0, preferably from 2.5 to 3.5, and most preferably about 3;

y is typically from 0.5 to 3.0, preferably about 1; and

z is typically from 0.1 to 1, preferably from 0.5 to 1.

M, in its broadest sense, is an element or mixture of elements which exhibits high carbon solubility and is typically a transition metal. It has been found that those transition metals such as Co, Fe, Ni, Mn and Cr, and alloys thereof, which are already known to exhibit diamond solvent/catalytic activity, are particularly effective constituents. However, other transition metals such as Pd and Pt, or the group IVA or VA metals such as Ti, Zr, V, Nb and Ta, for example, and rare earth metals such as Ce, Y, La and Sc, for example, are also suitable components.

M′ is typically a main group metal or metalloid such as Al, Ga, In, Ge, Sn, Pb, Tl, and Mg, for example. This group may, however, also include the transition metals Zn and Cd. Preferred examples of M′ include Sn, In and Pb.

Ternary carbides of the composition M₃M′C have been found to include the majority of compounds of interest that possess diamond sintering activity. However, there are some relevant compounds incorporating elements such as V, Nb and Ta that have stoichiometric values somewhat removed from this. Hence the preferred stoichiometric value range for x lies in the range from 2.5 to 5.0 and for y from 0.5 to 3.0. More preferably x lies in the range from 2.5 to 3.5 and y is preferably about 1. The carbon content of the ternary carbide is typically substoichiometric such that z is preferably in the range from 0.5 to 1.

Ultrahard diamond composite materials of the invention will typically include appreciable levels of ternary carbide in the binder matrix. The ternary carbide species should therefore preferably comprise at least 30 volume %, more preferably at least 40 volume %, of the binder phase. More preferably, the binder should only contain the ternary carbide and intermetallic species, such that no free or unbound M is present. Most preferably, the ternary carbide comprises the entirety of the binder matrix.

The ultrahard diamond composite materials will typically have a binder content of less than 30 volume %, preferably less than 20 volume %, more preferably less than 15 volume %, and most preferably less than 10 volume %.

As previously discussed, the modification of more standard transition metal solvent/catalyst systems to achieve a thermally stable PCD typically focuses on some method of reducing the catalytic efficacy of the binder in the final product. These methods may, for example, involve the formation of stable compounds, such as intermetallics, which effectively chemically bind the solvent/catalyst and render it inactive. Unfortunately, from a practical perspective, these modifications also tend to reduce the catalytic efficacy of the binder in the HpHT sintering environment, rendering the initial sintering of the diamond sub-optimal. Achieving a balance in reducing the chemical activity of the solvent/catalyst-based binder with respect to diamond in the final product, and yet still allowing it to operate effectively to catalyze the sintering of the diamond under HpHT conditions is clearly non-trivial.

It has now been found that, contrary to practical observation of many of the standard prior art intermetallic-modified binders, binder systems that contain appreciable levels of specific ternary carbides are able to achieve an optimally sintered diamond structure under HpHT conditions, particularly when producing PCD materials. These carbides, when present in the final product, are also able to render it more thermally stable by chemically binding the free M or solvent/catalyst-based binder.

It is postulated that many intermetallic binder-based systems are ineffective at achieving diamond sintering because the mechanism by which they should function requires the melt and dissociation of the intermetallic—hence liberating molten solvent/catalyst metal in situ as the sintering aid. If they have higher melting points, then this process may be hindered or may not be achieved at all under conventional HpHT conditions.

For example, of two intermetallic species occurring in the Co—Sn system, CoSn (atmospheric pressure melting point of 936° C.) and Co₃Sn₂ (atmospheric melting point of 1170° C.), only CoSn has been found to facilitate PCD sintering at conventional HpHT conditions, where temperatures are typically between about 1300 and 1450° C. and pressures between 50 and 60 kbar. Given the typical effect of pressure in significantly increasing melting points, it is likely that whilst CoSn is molten under HpHT conditions, Co₃Sn₂ is riot, or at least is insufficiently so. (One theory of melting behaviour predicts that a significant temperature excursion must be made above the melting point of a compound in order to disrupt its structure sufficiently to achieve the solution/diffusion properties of the melt.) Hence it may be hypothesised that the structure of the Co₃Sn₂ persists sufficiently in this case to prevent the carbon diffusion and association required to effect sintering.

It is surprising that the ternary carbides appear to function so well as sintering aids given that the melting points of many of the ternary carbides appear typically similar to many of those of the standard intermetallics that fail to provide PCD sintering under conventional HpHT conditions. For example, Co₃SnC_{0.7} is thought to melt at approximately 1100 to 1150° C. Hence for a given HpHT sintering window, there should be the same probability of the binder system in each case being molten and hence liberating solvent/catalyst metal for sintering. It is postulated in this invention that the observed increase in sintering efficacy of the ternary carbides may be the result of the already established presence of carbon in the crystal structure of the ternary carbide. This may then facilitate increased carbon mobility, even in the solid or semi-solid structure of the ternary carbide, near melt. Hence, even when very close to their melting points, these compounds may be able to transport carbon far more effectively than would otherwise have been expected.

Sintered PCD structures that contain this class of ternary carbides show a clear increase in thermal stability. This behaviour is likely to arise via the following mechanisms:
The thermal expansion coefficient of the ternary carbide and hence the modified binder is closer to that of the intergrown PCD network than that of the base solvent/catalyst. Hence, differential expansion as a response to increased temperature and the stresses resulting from this process are reduced.
In the solid state, the ternary carbide appears to have either a reduced or absent reactivity in contact with PCD. Hence even when temperatures are increased above those where standard metallic PCD becomes compromised, PCD containing these ternary carbides is more thermally stable. This is believed to extend to diamond composite materials having little or no diamond intergrowth

A further advantage of using a binder system modified by the formation of these ternary carbides stems from the precipitation or formation behaviour of the ternary carbides themselves. It appears that these carbide phases will preferentially form or distribute themselves at the phase boundaries formed between the binder and diamond phase material. Hence, even in metallurgies where the ternary carbide does not comprise the entirety (or even the majority) of the binder phase, i.e. where there is typically a significant amount of free solvent/catalyst, the ternary carbide phases can still function as a partial protective barrier between the remaining catalytically active binder phase and the diamond phase. This behaviour introduces a significant robustness to the binder composition range over which the ternary carbide can still effectively function to improve thermal stability.

However, whilst lower levels of ternary carbides within the binder may still be of advantage in terms of thermal stability, it is typically preferred that the ternary carbide content is maximized. The crux of the invention therefore lies in providing for the preferred formation of the ternary carbide within the metallurgy of the binder phase in the final diamond product. This preferred formation is typically at the expense of the standard intermetallic species (i.e. those that do not contain carbon in their crystal structure) that also occur within the chemical system.

Currently, the most effective means for providing for maximized formation of these carbide phases lies in selecting the correct composition with respect to M and M′, chiefly the ratio, M:M′. In the chemical systems of interest, it is typically possible to maximize the amount of the ternary carbide formed by biasing the M:M′ ratio away from that required for standard intermetallic species formation, and towards that of the ternary carbide. The Co—Sn—C system can be used to illustrate this principle.

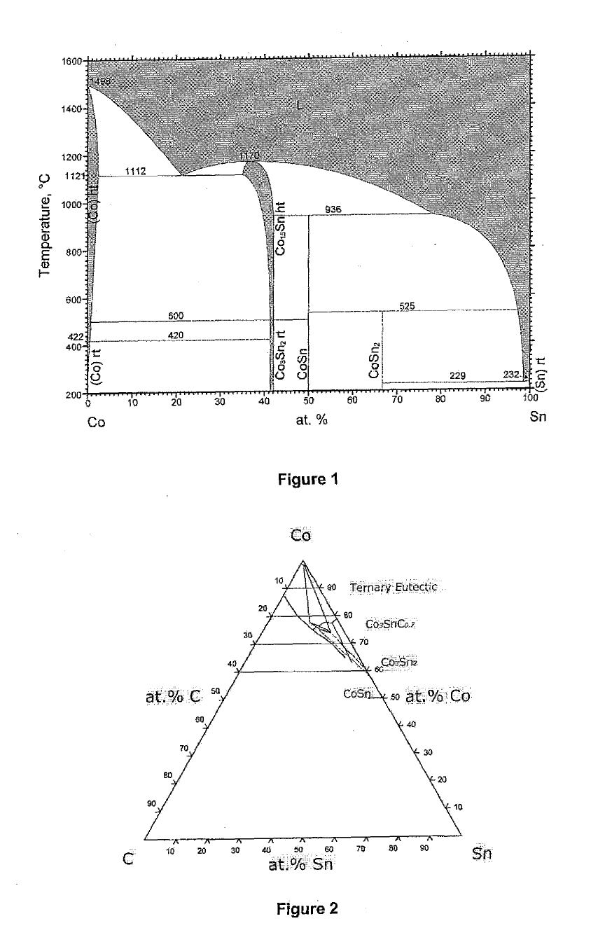

Referring to accompanying FIG. 1, there is shown a binary phase diagram for the simple Co—Sn system that shows the various Co—Sn intermetallics anticipated over the full range 100% Co to 100% Sn. There are three base intermetallic species typically observed, namely:
CoSn₂ with an atomic Co:Sn ratio of 1:2
CoSn with an atomic Co:Sn ratio of 1:1
Co₃Sn₂ with an atomic Co:Sn ratio of 3:2

According to standard metallurgical principles, maximizing the formation of any one of these individual intermetallics can be achieved simply through selection of the appropriate Co:Sn ratio window (and appropriate temperature conditions, according to the phase lines shown).

Referring now to accompanying FIG. 2, the more complex ternary phase diagram for the Co—Sn—C system shows the formation of two of these same base intermetallics, and the further presence of the ternary carbide, namely
CoSn with an atomic Co:Sn ratio of 1:1
Co₃Sn₂ with an atomic Co:Sn ratio of 3:2
Co₃SnC_{0.7} with an atomic Co:Sn ratio of 3:1

As for the binary phase mixture, by selecting the appropriate Co:Sn ratio window, it is possible preferentially to bias the metallurgy towards one particular compound.

For Co—Sn systems relevant to diamond sintering, i.e. in the presence of excess carbon, the maximum amount of the ternary carbide (Co₃SnC_{0.7}) is desired. The ratio of Co:Sn should therefore be as close as possible to 3:1; in other words, the optimal composition for the Co—Sn—C system lies at close to 75 atomic % Co and 25 atomic % Sn. It has been found that where the composition tends to be:
Sn-rich from this ratio (i.e. more than 25 atomic % Sn), then this will tend to lead to increasing amounts of Co₃Sn₂ formation. (Specifically in the Co—Sn system for PCD sintering, the formation of this intermetallic species has been found to be less desirable in terms of achieving an optimally sintered PCD end-product.);
Co-rich from this ratio (i.e. more than 75 atomic % Co), then the final diamond product tends to become less thermally stable, as the amount of “free” cobalt (i.e. which is not tied up in thermally stable compounds) increases. In practice, it has been found that there is a significant degree of flexibility in this latter threshold for Co—Sn, such that a significant degree of free cobalt can be accommodated before substantial thermal degradation effects are observed in the final product. As such for the Co—Sn system, it is preferred that where only a range window is practically achievable, then this focuses on the preferred composition (75:25 Co:Sn atomic) but may span the cobalt-rich portion of the compositional range.

The exemplary compositional range discussed above is specific to the Co—Sn system in terms of the sensitivities to the formation of an undesirable intermetallic on one side (M′-rich) and formation of free M (M rich) on the other side. However, these observations can easily be extended to general principles for other suitable chemical systems.

Diamond composite materials of the invention are generated by sintering diamond powder in the presence of a suitable metallurgy under HpHT conditions. They may be generated through standalone sintering, i.e. there is no further component other than the diamond powder and binder system mixture, or they may be generated on a backing of suitable cemented carbide material. In the case of the latter, they will typically be infiltrated by additional catalyst/solvent source from the cemented carbide backing during the HpHT cycle.

The diamond powder employed may be natural or synthetic in origin and will typically have a multimodal particle size distribution. It has also been found that it is advantageous to ensure that the surface chemistry of the diamond powder has reduced oxygen content in order to ensure that the ternary carbide constituents do not oxidize excessively prior to formation of the diamond composite material, reducing their effectiveness. Hence both the metal and diamond powders should be handled during the pre-sintering process with appropriate care, to ensure minimal oxygen contamination.

The ternary carbide phase metallurgy can be formed by several generic approaches, for example:
pre-reaction of M,M′ and C to generate the ternary carbide, typically under vacuum at temperature, which is then either admixed or infiltrated into the diamond powder feedstock under HpHT conditions;
in situ reaction under HpHT sintering conditions, preferably using an intimate homogenous mixture of the required components, which are typically elemental. This may be provided within the diamond powder mixture or from an infiltration layer or bed adjacent to it, and may include the carbon component, or this carbon component may be sourced from the diamond powder;
a staged in situ reaction under HpHT sintering conditions using a mixture of M′ and diamond powder and subsequent infiltration and in situ reaction with M from an external infiltration source (which may be provided by a carbide backing substrate).

Suitable preparation technologies for introducing the ternary carbide species or precursors into the diamond powder mixture include powder admixing, thermal spraying, precipitation reactions, vapour deposition techniques etc. An infiltration source can also be prepared using methods such as tape casting, pre-alloying etc.

The appropriate choice of M can also be used to manipulate the properties of the resultant diamond composite material, for example:
it has been found that maximizing the electronegativity difference between the M and M′ components and the M and C components can result in an increase in thermal stability. It is believed that maximizing the electronegativity differences between the constituent atoms increases bond strength within the ternary carbide and hence reduces the mobility of carbon within the lattice, particularly in the solid state. As carbon mobility decreases, so thermal stability will increase;
it has been found that specific M elements can be used to improve the physical, mechanical or chemical properties of the PCD. For example, M elements such as Pd and Pt impart increased oxidation resistance to the ternary carbide and hence the final PCD material.

It is also possible to use mixed ternary carbides (with more than one M component) where it is desirable to modify the properties of the resultant diamond composite material. For example, the addition of an element such as Ce to a ternary Co₃InC carbide binder system (hence forming the mixed ternary carbide (CoCe)₃InC) results in a PCD with improved thermal stability over the initial Co₃InC-based PCD.

In order to evaluate the diamond composite materials of the invention, in addition to electron microscopy (SEM) and XRD analysis, thermal stability (ST) and thermal wear behaviour application-based (milling) tests were used.

A thermal stability test is typically used as a research measure of the effective thermal stability of a standalone (i.e. unbacked) small, PCD sample. The suitably-sized sample to be tested is thermally stressed by heating under vacuum at ˜100° C./hour to 850° C., held at 850° C. for 2 hours, and then slowly cooled to room temperature. After cooling, Raman spectroscopy is conducted to detect the presence of graphitic carbon or non-sp³ carbon resulting from the thermal degradation of the diamond. This type of heat treatment is considered to be very harsh, where a commercially available Co-based PCD showed a significant graphite peak after such treatment. A reduced conversion of diamond to graphite is indicative of an increase in thermal stability of the material.

Results for this test have been reported as a relative ratio of the height of the graphitic (sp²) peak to the diamondiferous (sp^{a}) peak—where a higher value (i.e. close to 1) shows significant graphitization, and a lower value (<0.5) shows a more thermally stable product.

A thermal wear behaviour application-based test can be used as an indicator of the degree to which a PCD-based material will survive in a thermally demanding environment.

The test is conducted on a milling machine including a vertical spindle with a fly cutter milling head at an operatively lower end thereof. Rock, in particular granite, is milled by way of a dry, cyclic, high revolution milling method. The milling begins at an impact point where the granite is cut for a quarter of a revolution, the granite is then rubbed by the tool for a further quarter revolution and the tool is then cooled for half a revolution at which point the tool reaches the impact point. For an unbacked cutting tool, a shallow depth milling of the rock is carried out—typically a depth of cut of about 1 mm is used. For a backed tool, the depth of cut is increased, typically to about 2.5 mm.

The length of the rock that has been cut prior to failure of the tool is then measured, where a high value indicates further distance travelled and a good performance of the tool, and a lower value indicates poorer performance of the tool. As the test is a dry test, the failure of the tool is deemed to be thermally induced rather than abrasion induced. Hence this test is a measure of the degree to which the tool material will wear in a thermally stressed application.

The invention will now be described in more detail, by way of example only, with reference to the following illustrative example.

### Examples

### Example 1

### Co—Sn—C system

### 1A. PCD sintered with Co₃SnC_{0.7}-based binder

A mixture of Co and Sn metal powders in the correct (3:1) atomic ratio was prepared. A bed of multimodal diamond powder of approximately 20 microns in average diamond grain size was then placed into a niobium metal canister and a layer of the metal powder mixture sufficient to provide a binder constituting 10 volume % of the diamond was placed onto this powder bed. The canister was then evacuated to remove air, sealed and treated under HpHT conditions at approximately 55 kbar and 1400° C. to sinter the PCD.

The sintered PCD compact was then removed from the canister and examined using:
scanning electron microscopy (SEM) for evidence of intergrowth
XRD analysis to determine the phases present in the binder; and
a thermal stability test as described above.

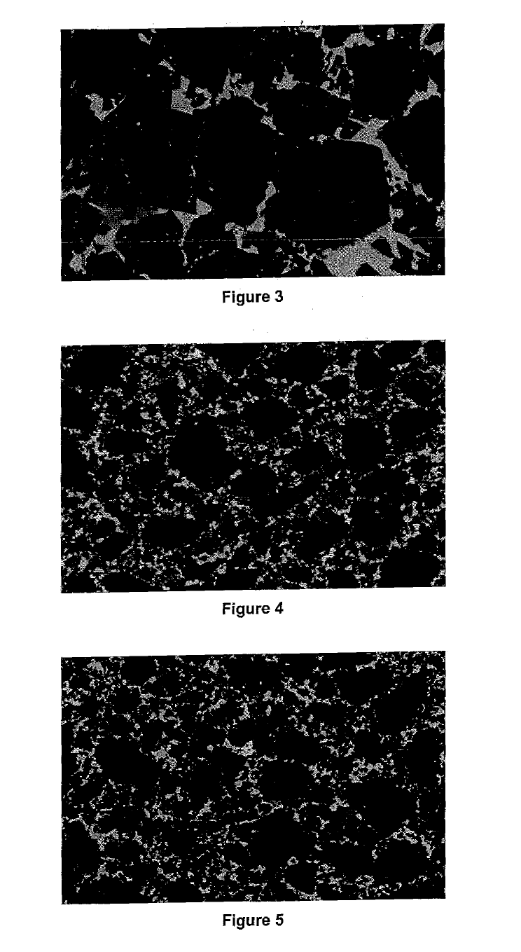

The PCD material produced showed clear evidence of intergrowth between the diamond grains when examined under the SEM, as is evident from the high magnification micrograph shown in accompanying FIG. 3. XRD analysis confirmed the presence of Co₃SnC_{0.7} as the dominant phase present in the binder.

### 1B. Carbide backed PCD sintered with (Co₃SnC_{0.7} Co)-based binder

A sample was prepared according to the method described above for Example 1A, save that the Co:Sn ratio of the powder mixture used was 1:1; and the diamond and metal powders were mixed together using a planetary ball mill (with the metal powder mixture constituting 7.5 weight % of the mixture) before being placed on a cemented carbide substrate within the niobium canister. During sintering, additional Co from the carbide substrate infiltrated the diamond/CoSn mixture such that the required stoichiometry for the formation of Co₃SnC_{0.7} was achieved, and additional free cobalt (i.e. not bound in the carbide) was observed.

The sample was then examined using:
scanning electron microscopy for evidence of intergrowth;
XRD analysis to determine the phases present in the binder; and
a thermal wear behaviour application-based test as per the procedure described above.

The PCD material produced showed clear evidence of intergrowth between the diamond grains when examined under the SEM, as is evident from the micrograph shown in accompanying FIG. 4. XRD analysis confirmed the presence of Co₃SnC_{0.7} as well as free or metallic Co as phases present in the binder.

### 1C. Carbide backed PCD sintered with Co₃SnC_{0.7} binder

A sample was prepared according to the method described for Example 1A above, save that the Co:Sn ratio of the powder mixture used was 1:1. A layer of this metal powder mixture (sufficient to constitute 20 weight % of the diamond powder mass) was then placed onto a cemented carbide substrate within the niobium canister, with the diamond powder layer placed on top of this. During sintering, additional Co from the carbide substrate infiltrated the CoSn layer and then the diamond powder such that the required stoichiometry for the formation of Co₃SnC_{0.7} was achieved. No free cobalt (i.e. not bound in the carbide) was observed in the binder of the final PCD microstructure.

The sample was then examined using:
scanning electron microscopy for evidence of intergrowth;
XRD analysis to determine the phases present in the binder; and
a thermal wear behaviour application-based test as per the procedure described above.

The PCD material produced showed clear evidence of intergrowth between the diamond grains when examined under the SEM, as is evident from the micrograph shown in accompanying FIG. 5. XRD analysis confirmed the presence of Co₃SnC_{0.7} as the dominant phase present in the binder.

### Example 2

### Fe-based ternary carbides (Fe₃SnC+Fe₃InC)

Two samples of PCD sintered in the presence of a binder dominated by Fe₃SnC (designated 2A) and Fe₃InC (designated 2B), respectively, were prepared.

A mixture of Fe and the Sn or In metal powder in the correct (3:1) atomic ratio was prepared. A bed of multimodal diamond powder of approximately 20 microns in average diamond grain size was then placed into a niobium metal canister and a layer of the metal powder mixture sufficient to provide a binder constituting 10 volume % of the diamond was placed onto this powder bed. The canister was then evacuated, sealed and treated under HpHT conditions at approximately 55 kbar and 1400° C. to sinter the PCD.

The sintered PCD compact was then removed from the canister and examined using:
scanning electron microscopy (SEM) for evidence of intergrowth;
XRD analysis to determine the phases present in the binder;
a thermal stability test as previously described; and
a thermal wear behaviour application-based test as previously described.

In each case, the PCD material produced showed clear evidence of intergrowth between the diamond grains when examined under the SEM.

### Example 3

### (CoCe)InC

### 3A. PCD sintered with Co₃InC-based binder

A sample of PCD sintered in the presence of a binder dominated by Co₃InC was prepared.

A mixture of Co and In metal powders in the correct (3:1) atomic ratio was prepared. A bed of multimodal diamond powder of approximately 20 microns in average diamond grain size was then placed into a niobium metal canister and a layer of the metal powder mixture sufficient to provide a binder constituting 10 volume % of the diamond was placed onto this powder bed. The canister was then evacuated, sealed and treated under HpHT conditions at approximately 55 kbar and 1400° C. to sinter the PCD.

The sintered PCD compact was then removed from the canister and examined using:
scanning electron microscopy (SEM) for evidence of intergrowth;
XRD analysis to determine the phases present in the binder; and
a thermal stability test as described above.

The PCD material produced showed evidence of intergrowth between the diamond grains when examined under the SEM. However, when subjected to the thermal stability test, the resultant material performed poorly. This lack of thermal stability was ascribed to an insufficient electronegativity difference between In and C.

### 3B. PCD sintered with Co₃InC-based binder, modified by the addition of Ce

A sample of PCD sintered in the presence of a binder dominated by Co₃InC with the addition of Ce was prepared. This sample was prepared according to the method described above for Example 3A, save that Ce metal powder was introduced into the metal powder mix in a ratio of 1:6 to the In metal. This resulted in the formation of a mixed Co/Ce ternary carbide in the binder.

The resultant PCD was then examined using:
scanning electron microscopy (SEM) for evidence of intergrowth;
XRD analysis to determine the phases present in the binder; and
a thermal stability test as described above.

Results from the thermal stability test clearly indicated a significant improvement in thermal stability. The use of Ce in solution, partially replacing the Co as the M component, results in an average increase in the electronegativity differences and an increase in thermal stability.

Set out below in Table 1 is a summary of certain data from Examples 1 to 3 above. Included for comparative purposes is data for standard Co-sintered PCD materials, designated as C1 and C2.

TABLE 1

| | | | Thermal stability tests | |
|---|---|---|---|---|
| | Target | Dominant | | Milling |
| | ternaryarbide | binder phases | TS sp²/sp³ | Cutting |
| # | binder system | present by XRD | Raman ratio | length (mm) |
| C1 | Co | | 0.9 | 1400 |
| C2 | | | | 1090* |
| 1A | Co₃SnC | Co₃SnC_{0.7} | 0.22 | 5400 |
| 1B | Co₃SnC | Co₃SnC_{0.7}; Co | — | 1340* |
| 1C | Co₃SnC | Co₃SnC_{0.7}; Co₃Sn₂ | — | 5600* |
| 2A | Fe₃SnC | Fe₃SnC | 0.17 | 5110 |
| 2B | Fe₃InC | Fe₃InC | 0.08 | 1500 |
| 3A | Co₃InC | Co₃InC | 0.75 | — |
| 3B | (CoCe)₃InC | | 0.19 | — |

These samples were tested as backed samples i.e. with a 2.5 mm depth of cut

It is evident from these results that the use of intermetallic-based ternary carbides can significantly improve the thermal stability of the resultant diamond composite material.

Samples 1A, 1B and 1C show the effect of using the Co₃SnC binder in both backed and unbacked PCD. It is evident from the reduced thermal performance of 1B that free Co (i.e. unbound by an intermetallic ternary carbide structure) has a detrimental effect, even though this material still itself showed an improvement over the comparative Co-based backed PCD sample C2.

Observation of samples 2A and 2B shows that whilst the Fe₃InC sample performed extremely well in the TS test, the milling test results indicated that it was sub-optimal when compared with the Fe₃SnC material, which performed better in the application-based test. This observation was supported by visual inspection which showed some cracking in the sample.

The results for samples 3A and 3B clearly show the positive effect on thermal stability of using a mixed ternary nitride to increase the electronegativity differences between the constituents.

1. An ultrahard composite material comprising a diamond phase and a binder phase, the binder phase comprising a ternary carbide of the general formula:
Mₓ M′_{y} C_{z}
wherein;
M is at least one metal selected from the group consisting of the transition metals and the rare earth metals;
M′ is a metal selected from the group consisting of the main group metals or metalloid elements and the transition metals Zn and Cd;
x is from 2.5 to 5.0;
y is from 0.5 to 3.0; and
z is from 0.1 to 1.

2. An ultrahard composite material according to claim 1, wherein M is selected from the group consisting of Co, Fe, Ni, Mn, Cr, Pd, Pt, V, Nb, Ta, Ti, Zr, Ce, Y, La and Sc.

3. An ultrahard composite material according to claim 1, wherein M′ is selected from the group consisting of Al, Ga, In, Ge, Sn, Pb, Tl, Mg, Zn and Cd.

4. An ultrahard composite material according to claim 1, wherein M′ is Sn, In or Pb.

5. An ultrahard composite material according to claim 1, wherein x is from 2.5 to 3.5.

6. An ultrahard composite material according to claim 1, wherein x is 3.

7. An ultrahard composite material according to claim 1, wherein y is 1.

8. An ultrahard composite material according to claim 1, wherein z is from 0.5 to 1.

9. An ultrahard composite material according to claim 1, wherein the ternary carbide comprises at least 30 volume % of the binder phase.

10. An ultrahard composite material according to claim 1, wherein the ternary carbide comprises at least 40 volume % of the binder phase.

11. An ultrahard composite material according to claim 1, wherein the binder phase comprises only ternary carbide and one or more other intermetallic compounds, such that no free or unbound M is present in the binder phase.

12. An ultrahard composite material according to claim 1, wherein the binder phase comprises only ternary carbide.

13. An ultrahard composite material according to claim 1, wherein the binder phase comprises less than about 30 volume % of the ultrahard composite material.

14. An ultrahard composite material according to claim 1, wherein the binder phase comprises less than about 20 volume % of the ultrahard composite material.

15. An ultrahard composite material according to claim 1, wherein the binder phase comprises less than about 15 volume % of the ultrahard composite material.

16. An ultrahard composite material according to claim 1, wherein the binder phase comprises less than about 10 volume % of the ultrahard composite material.

17. An ultrahard composite material according to claim 1, which is a high pressure and high temperature sintered material.

18. An ultrahard composite material according to claim 1, wherein the diamond phase is polycrystalline diamond defined by substantial diamond intergrowth.

19. An ultrahard composite material according to claim 1, wherein the ratio of M:M′ is approximately 3:1.

20. A diamond abrasive compact comprising an ultrahard composite material according to claim 1.

21. A tool comprising a diamond abrasive compact according to claim 20, capable for use in a cutting, milling, grinding, drilling or other abrasive application.
